(19) United States
(12) Patent Application Publication
(10) Pub. No.: US 2026/0043610 A1
(43) Pub. Date: Feb. 12, 2026

(54) IMPROVED OPERATION OF AN INDUCTION FURNACE

(71) Applicants: PRIMETALS TECHNOLOGIES AUSTRIA, Linz (AT); ABP INDUCTION SYSTEMS GMBH, Dortmund (DE)

(72) Inventors: Kerstin Baumgartner, Katsdorf (AT); Markus Mohr, Dortmund (DE); Gero Schwarz, Attnang (AT); Andrej Umbrasko, Holzwickede (DE); Michael Zahedi, St. Marien (AT)

(73) Assignees: PRIMETALS TECHNOLOGIES AUSTRIA GMBH, Linz (AT); ABP INDUCTION SYSTEMS GMBH, Dortmund (DE)

(21) Appl. No.: 19/140,237

(22) PCT Filed: Nov. 17, 2023
(86) PCT No.: PCT/EP2023/082206

§ 371 Date: Jun. 17, 2025

(30) Foreign Application Priority Data
Dec. 19, 2022 (EP) 22214596.3

(51) Int. Cl. F27B 9/28; F27D 11/06; H05B 6/40; H05B 6/44

(52) U.S. Cl. CPC F27B 9/28; F27D 11/06; H05B 6/40; H05B 6/44

(57) ABSTRACT

Induction furnace, method for operating, control program, and control device for an inducation furnace for heating planar rolled stock material made of metal. The rolled stock passes through the induction furnace in a longitudinal direction and extends transversely thereto from a first to a second rolled stock edge. The induction furnace has a plurality of module pairs which, viewed in the longitudinal direction, follow one another sequentially and each have a first and a second induction module. The induction modules, as viewed in the transverse direction, are positioned at a respective initial position, so that the first induction modules are arranged offset towards the first rolled stock edge and the second induction modules are arranged offset towards the second rolled stock edge. Induction modules are supplied with electrical power via respective power supply devices. A respective electrical target variable is defined for each induction module.

### CROSS-REFERENCE TO RELATED APPLICATIONS

The present application is a national phase application of PCT Application No. PCT/EP2023/082206, filed Nov. 17, 2023, entitled “IMPROVED OPERATION OF AN INDUCTION FURNACE”, which claims the benefit of European Patent Application No. 22214596.3, filed Dec. 19, 2022, each of which is incorporated by reference in its entirety.

### BACKGROUND OF THE INVENTION

### 1. Field of the Invention

The present invention is directed to a heating method for a flat rolled stock made of metal in an induction furnace, a control program for a control device of an induction furnace, in which a flat rolled stock made of metal is to be heated, a control device of an induction furnace, and an induction furnace for heating a flat rolled stock made of metal.

### 2. Description of the Related Art

The mentioned subjects are generally known to those skilled in the art. Solely by way of example, reference can be made to WO 2011/009 819 A1.

A heating method for a flat rolled stock made of metal in an induction furnace is known from WO 2004/000 476 A1, in which the rolled stock passes through the induction furnace in a longitudinal direction and extends from a first to a second rolled stock edge in a transverse direction running transverse to the longitudinal direction. The induction furnace comprises a plurality of module pairs, which follow one another sequentially viewed in the longitudinal direction and each comprise a first and a second induction module. The induction modules are positioned at a respective starting position viewed in the transverse direction. The starting positions are determined such that the first induction modules are arranged offset toward the first rolling stock edge and the second induction modules are arranged offset toward the second rolling stock edge. The temperature profile of the rolled stock in the transverse direction is thus to be influenced.

### SUMMARY OF THE INVENTION

The present invention is directed to a heating method for a flat rolled stock made of metal in an induction furnace,
wherein the rolled stock passes through the induction furnace in a longitudinal direction and extends from a first to a second rolled stock edge in a transverse direction running transverse to the longitudinal direction,
wherein the induction furnace comprises a plurality of module pairs,
wherein the module pairs follow one another sequentially viewed in the longitudinal direction and each comprise a first and a second induction module,
wherein the induction modules are positioned at a respective starting position viewed in the transverse direction,
wherein the starting positions are determined such that the first induction modules are arranged offset toward the first rolled stock edge and the second induction modules are arranged offset toward the second rolled stock edge,
wherein the induction modules are each supplied with electric energy via a separate energy supply device assigned proprietarily to the respective induction module,
wherein a respective electric setpoint variable is defined for the induction modules,
wherein it is monitored whether electric actual variables, using which the induction modules are operated, correspond to their respective setpoint variables.

The present invention is furthermore directed to a control program for a control device of an induction furnace, in which a flat rolled stock made of metal is to be heated,
wherein the rolled stock passes through the induction furnace in a longitudinal direction and extends from a first to a second rolled stock edge in a transverse direction running transverse to the longitudinal direction,
wherein the induction furnace comprises a plurality of module pairs,
wherein the module pairs follow one another sequentially viewed in the longitudinal direction and each comprise a first and a second induction module,
wherein the induction modules are positioned at a respective starting position viewed in the transverse direction,
wherein the starting positions are determined such that the first induction modules are arranged offset toward the first rolled stock edge and the second induction modules are arranged offset toward the second rolled stock edge,
wherein the induction modules are each supplied with electric energy via a separate energy supply device assigned proprietarily to the respective induction module,
wherein a respective electric setpoint variable is defined for the induction modules,
wherein the control program comprises machine code executable by the control device, wherein the execution of the machine code by the control device causes the control device to monitor whether electric actual variables, using which the induction modules are operated, correspond to their respective setpoint variables.

The present invention is furthermore directed to a control device of an induction furnace, in which a flat rolled stock made of metal is to be heated, wherein the control device is programmed using a control program such that the control device operates the induction furnace according to such a heating method.

The present invention is furthermore directed to an induction furnace for heating a flat rolled stock made of metal, which passes through the induction furnace in a longitudinal direction and extends from a first to a second rolled stock edge in a transverse direction running transversely to the longitudinal direction,
wherein the induction furnace comprises a plurality of module pairs,
wherein the module pairs follow one another sequentially viewed in the longitudinal direction and each comprise a first and a second induction module,
wherein the induction modules are positioned at a respective starting position viewed in the transverse direction,
wherein the starting positions are determined such that the first induction modules are arranged offset toward the first rolled stock edge and the second induction modules are arranged offset toward the second rolled stock edge,
wherein the induction modules are each supplied with electric energy via a separate energy supply device assigned proprietarily to the respective induction module,
wherein the induction furnace comprises a control device, which controls the induction furnace according to such a heating method.

Before the hot rolling of a flat rolled stock made of metal, in particular made of steel, the rolled stock has to be brought to the temperature required for the hot rolling. Furthermore, temperature differences which occur within the flat rolled stock also have to be equalized as much as possible. The heating of such a flat rolled stock and the equalization of temperature differences take place in a furnace.

The associated furnaces can be designed in various ways. They are often induction furnaces through which the rolled stock passes in a longitudinal direction. This procedure is typical in particular in an endless facility, in which the rolled stock is fed to the rolling line directly from the casting heat. The rolled stock can be divided as needed into individual slabs or the like before the rolling or also not divided.

To generate the eddy currents in the flat rolled stock, which cause the corresponding heating via the intrinsic ohmic resistance of the flat rolled stock, longitudinal field modules or transverse field modules can be used as induction modules. In practice, the heating is usually carried out by means of longitudinal field modules in the case of a relatively thick rolled stock. Longitudinal field modules are positioned centrally in relation to the rolled stock. Their positioning is no longer changed thereafter. With relatively thin rolled stock, the heating is usually carried out by means of transverse field modules.

Transverse field modules are generally positioned off-center in relation to the rolled stock. A single transverse field module therefore generally causes an asymmetrical heating of the rolled stock viewed in the transverse direction of the rolled stock. In particular, one of the two rolled stock edges is heated more strongly than the other rolled stock edge. To avoid an asymmetrical heating of the rolled stock, the transverse field modules are therefore combined to form module pairs, wherein each one of the two modules heats one or the other rolled stock edge more strongly. The combination of the two transverse field modules of the respective module pair causes—at least substantially—symmetrical heating of the rolled stock.

It can occur in operation of the induction furnace that a single induction module completely or partially fails. In the prior art, in this case the respective other induction module of the corresponding module pair is switched off or its operation is reduced to still effectuate symmetrical heating of the rolled stock. This already causes a significant reduction of the overall energy which can be introduced into the flat rolled stock by means of the induction furnace. If a further induction module of another module pair additionally completely or partially fails, the same procedure will also be taken for the other induction module of this module pair. This situation thus becomes even more severe. The result can be disturbances in the operation of the rolling line downstream from the induction furnace.

The object of the present invention is to provide possibilities by means of which the effects of the—complete or partial—failure of a single induction module or also multiple induction modules are kept as minor as possible.

The object is achieved by a heating method having the features of the claims. Advantageous embodiments of the heating method are the subject matter of the dependent claims.

According to the invention, a heating method of the type mentioned at the outset is designed such that in the case that exclusively an actual variable, using which one of the first induction modules is operated, has a reduced value in relation to its corresponding setpoint variable, while maintaining the operation of all second induction modules, both the setpoint variables for the first induction modules, which are upstream from that first induction module, the actual variable of which has a reduced value in relation to its corresponding setpoint variable, and also the setpoint variables for the first induction modules which are downstream from that first induction module, the actual variable of which has a reduced value in relation to its corresponding setpoint variable, are increased, so that a decreased heating of the rolled stock caused by the reduced actual variable is compensated for as much as possible.

In particular the load of the second induction modules thus remains as low as possible. The setpoint variables for the second induction modules can often be maintained unchanged. However, even if the setpoint variables of the second induction modules are varied, the second induction modules are operated further.

If a compensation of the reduced heating of the rolled stock is not possible, in general the second setpoint variables of a plurality of the second induction modules are reduced. On the one hand, uniform or at least symmetrical heating of the rolled stock viewed in the width direction of the rolled stock can still be ensured, wherein the change of the heating is still distributed to the areas of effect of a plurality of second induction modules.

Often, in the event of a complete or partial failure of exclusively a first induction module, no further measures are necessary. However, the second induction modules can optionally additionally be moved toward starting from their respective starting positions. Asymmetries in the temperature profile of the rolled stock can thus be counteracted.

Preferably, furthermore in the case that both an actual variable using which one of the first induction modules is operated and an actual variable using which one of the second induction modules is operated have a reduced value in relation to their corresponding setpoint variable, the setpoint variables for the first induction modules, which are upstream from that first induction module, the actual variable of which has a reduced value in relation to its corresponding setpoint variable, the setpoint variables for the first induction modules, which are downstream from that first induction module, the actual variable of which has a reduced value in relation to its corresponding setpoint variable, the setpoint variables for the second induction modules, which are upstream from that second induction module, the actual variable of which has a reduced value in relation to its corresponding setpoint variable, and the setpoint variables for the second induction modules, which are downstream from that second induction module, the actual variable of which has a reduced value in relation to its corresponding setpoint variable, are increased, so that a decreased heating of the rolled stock caused by the reduced actual variables is compensated for as much as possible. The effects of the complete or partial simultaneous failure of a first and a second induction module can thus be kept as small as possible.

Often, no further measures are also required in the event of a complete or partial simultaneous failure of both a first induction module and a second induction module. However, the first and second induction modules can optionally additionally be moved starting from their respective starting positions. A one-sided heating of a rolled stock edge in relation to the other rolled stock edge can thus also be counteracted if necessary.

Additional values, by which the setpoint variables for the first and second induction modules are increased or reduced, can be determined as needed. In the simplest case—separately for first and second induction modules—a uniform distribution takes place onto the remaining induction modules. However, it leads to better results if the additional values are determined as a function of an initial temperature profile of the flat rolled stock before the feed to the induction furnace, operating parameters of the induction furnace (for example, a transport speed at which the rolled stock is conveyed through the induction furnace, or a passage time which the rolled stock requires to pass through the induction furnace), and a desired final temperature profile of the flat rolled stock after emerging from the induction furnace. This possibly also applies for position changes by which the induction modules are moved.

The object is furthermore achieved by a control program having the features of the claims. An advantageous embodiment of the control program is the subject matter of the dependent claims.

According to the invention, the execution of the control program by the control device causes the control device, in addition to the above-mentioned measures, in the case in which exclusively an actual variable using which one of the first induction modules is operated has a reduced value in relation to its corresponding setpoint variable, while maintaining the operation of all second induction modules, to increase both the setpoint variables for the first induction modules which are upstream from that first induction module, the actual variable of which has a reduced value in relation to its corresponding setpoint variable, and also the setpoint variables for the first induction modules, which are downstream from that first induction module, the actual variable of which has a reduced value in relation to its corresponding setpoint variable, so that reduced heating of the rolled stock caused by the reduced actual variable is compensated for as much as possible.

Preferably, the execution of the machine code by the control device additionally causes the control device to also implement the additional measures of the advantageous embodiments of the heating method.

The object is furthermore achieved by a control device having the features of the claims. According to the invention, the control device is programmed using a control program according to the invention, so that the control device operates the induction furnace according to a heating method according to the invention.

The object is furthermore achieved by an induction furnace having the features of claim 10. According to the invention, in an induction furnace of the type mentioned at the outset, the control device of the induction furnace is designed as a control device according to the invention.

### BRIEF DESCRIPTION OF THE DRAWINGS

The above-described properties, features, and advantages of this invention and the manner in which they are achieved will become clearer and more comprehensible in conjunction with the following description of an exemplary embodiment, which is explained in more detail in conjunction with the drawings. In the figures:

FIG. 1 shows an induction furnace and a rolled stock from the side,

FIG. 2 shows the induction furnace and the rolled stock from FIG. 1 from above,

FIG. 3 shows a flow chart,

FIG. 4 shows a further flow chart,

FIG. 5 shows a further flow chart,

FIG. 6 shows a further flow chart, and

FIG. 7 shows a further flow chart.

### DETAILED DESCRIPTION

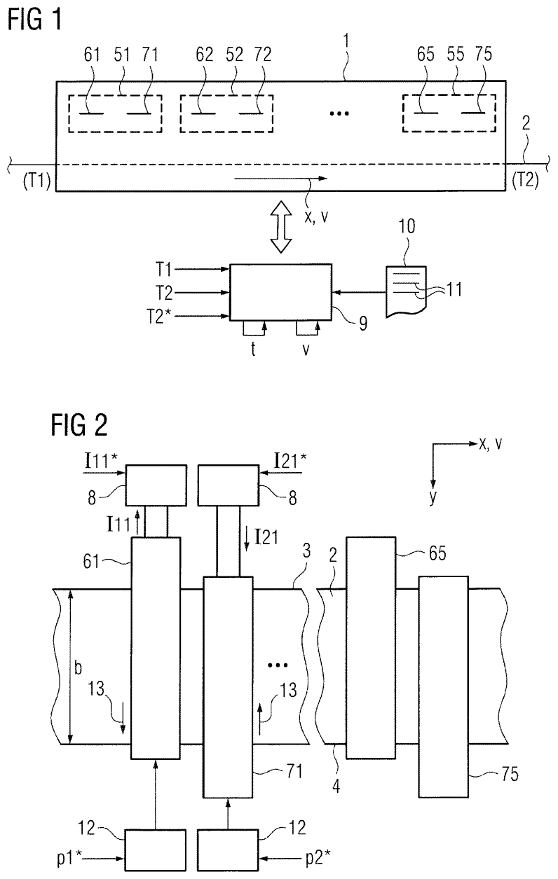

According to FIG. 1, a flat rolled stock 2 is to be heated in an induction furnace 1. The rolled stock 2 consists of metal, often of steel. The rolled stock 2 passes through the induction furnace 1 in a longitudinal direction x. It extends according to FIG. 2 in a transverse direction y, which runs transversely to the longitudinal direction x, from a first rolled stock edge 3 to a second rolled stock edge 4. The rolled stock 2 has an initial temperature profile T1 upon entry into the induction furnace 1. Upon departure from the induction furnace 1, the rolled stock 2 has a final temperature profile T2. The temperature profiles T1, T2 are location-resolved at least in the transverse direction y. The temperature profiles T1, T2 can also vary in the longitudinal direction x.

Such an induction furnace 1 is often used in a rolling line. It is used to heat the rolled stock 2 before the rolling and/or to make the final temperature profile T2 uniform in the transverse direction y. In particular, the final temperature profile T2 is generally to be symmetrical viewed in the transverse direction y. In many cases, the temperature of the rolled stock 2 is already relatively high upon entry into the induction furnace 1. This is true in particular if the induction furnace 1 is arranged between a continuous casting facility and a rolling line or is arranged between a roughing rolling mill and a finishing line.

The induction furnace 1 comprises a plurality of module pairs 5. The module pairs are each supplemented with a further number in FIGS. 1 and 2, thus designated as module pair 51, 52, etc. If a very special module pair 5 is not being discussed hereinafter, only the so-to-speak abbreviated reference sign 5 is used hereinafter. If reference is made to a very specific module pair 51 to 55, the so-to-speak complete reference sign 51, 52, etc. is used. Solely by way of example, it is furthermore assumed hereinafter that five module pairs 5 are present. The present invention is explained hereinafter in conjunction with this number of module pairs 5. However, the number of module pairs 5 could also be greater, for example, it could be six, seven, or eight. Likewise, the number of module pairs 5 could also be smaller, for example, three or four. However, two module pairs 5 are present at minimum.

The module pairs 5 follow one another sequentially viewed in the longitudinal direction x. They each comprise a first and a second induction module 6, 7. A separate energy supply device 8 is proprietarily assigned to each of the induction modules 6, 7. The respective energy supply device 8 is only shown in the frontmost two induction modules 6, 7. It can be designed, for example, as an inverter, which is fed via a DC voltage circuit. The respective induction module 6, 7 is supplied with electric energy via the respective energy supply device 8. Analogously to the module pairs 5, the induction modules 6, 7 are supplemented with a further number hereinafter as needed for individualization, thus as induction module 61, 62, etc. If a very special induction module 6, 7 is not being discussed hereinafter, only the so-to-speak abbreviated reference sign 6, 7 is used hereinafter.

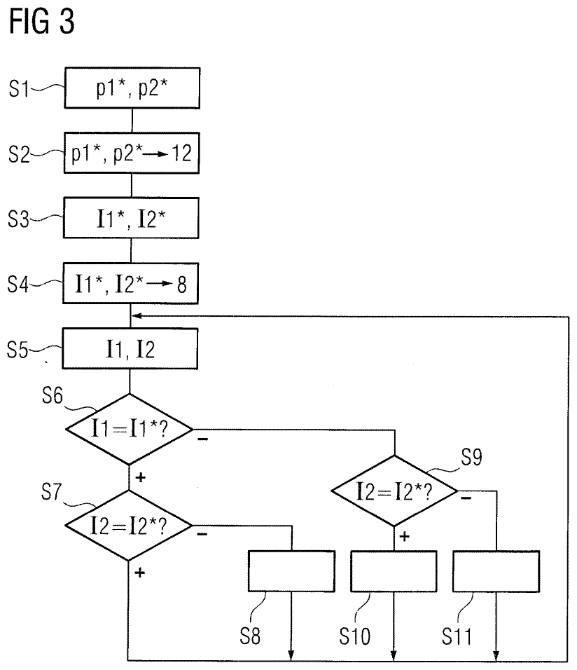

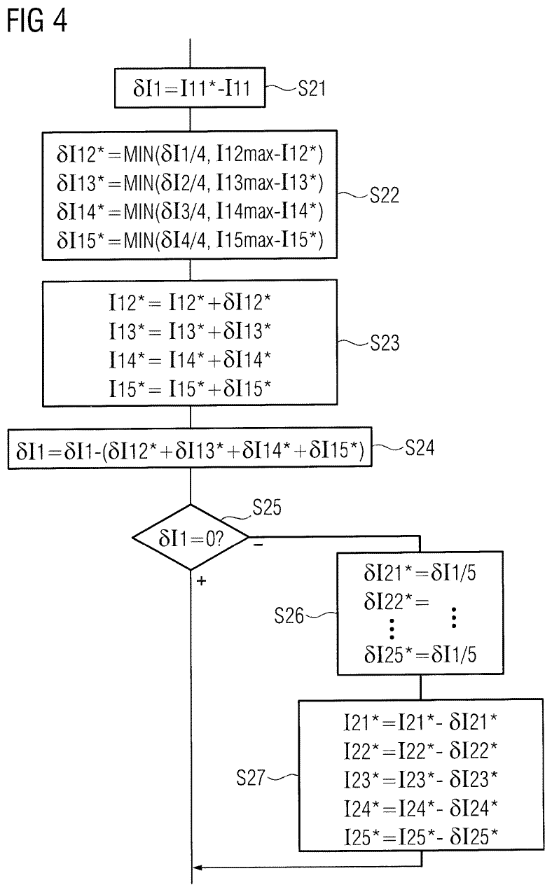

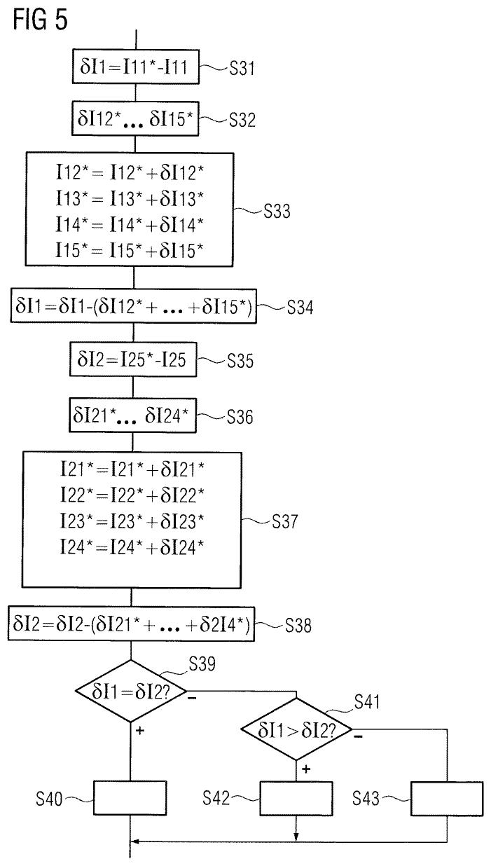

The induction furnace 1 furthermore comprises—see FIG. 1—a control device 9. The control device 9 is programmed using a control program 10. The control program 10 comprises machine code 11. The machine code 11 is executable by the control device 9. The control device 9 operates the induction furnace 1 according to a heating method for the rolled stock 2 on the basis of the programming of the control device 9 using the control program 10 or the execution of the machine code 11 by the control device 9. This heating method is explained in more detail hereinafter—initially in conjunction with FIG. 3, later also with reference to FIGS. 4 and 5.

According to FIG. 3, the control device 9, in a step S1, defines respective first starting positions p1* for the first induction modules 6 and respective second starting positions p2* for the second induction modules 7. The first and second starting positions p1*, p2* are determined by the control device 9 as a function of the width b of the rolled stock 2. The first and second starting positions p1*, p2* are determined by the control device 9 such that—presuming a corresponding positioning of the induction modules 6, 7—the first induction modules 6 are arranged offset toward the first rolled stock edge 3 and the second induction modules 7 are arranged offset toward the second rolled stock edge 4. This is apparent in particular from FIG. 2. The first starting positions p1* are generally uniform for the first induction modules 6. In principle, however, they can also be individually determined. Likewise, the second starting positions p2* are also generally uniform for the second induction modules 7. In principle, however, they can also be individually determined.

In a step S2, the control device 9 outputs the starting positions p1*, p2* (more precisely: the corresponding values) to corresponding positioning devices 12 (see FIG. 2). The first and second induction modules 6, 7 are thus positioned on their respective starting position p1*, p2*. The positioning devices 12 are also only shown for the frontmost two induction modules 6, 7 in FIG. 2. The positioning devices 12 can be designed, for example, as hydraulic cylinder units.

Furthermore, the control device 9 defines, in a step S3, first electric setpoint variables I1* for the first induction modules 6 and second electric setpoint variables I2* for the second induction modules 6. In general, the first setpoint variables I1* are uniform for the first induction modules 6. Likewise, in general the second setpoint variables I2* are also uniform for the second induction modules 7. In principle, the setpoint variables I1*, I2* can also be individually determined, however. For example, the setpoint variables I1*, I2* can rise or fall linearly viewed in the longitudinal direction x or can also rise or fall more strongly or weakly than linearly.

The control device 9, in a step S4, outputs the determined setpoint variables I1*, I2* (more precisely: the corresponding values) to the corresponding energy supply devices 8. On the basis of this specification, the energy supply devices 8 impinge the induction modules 6, 7 accordingly. The induction modules 6, 7 are thus operated using actual variables I1, I2, which correspond to the setpoint variables I1*, I2*.

The setpoint variables I1*, I2* and therefore also the actual variables I1, I2 can be determined as needed. These can in particular be voltages, currents, or powers.

Analogously to the induction modules 6, 7, the setpoint variables I1*, I2* and the actual variables I1, I2 are supplemented hereinafter as needed with a further number for individualization, thus, for example, designated as the setpoint variable I12* or as the actual variable I11. If a very special setpoint variable I1*, I2* or actual variable I1, I2 is not discussed hereinafter, only the so-to-speak abbreviated reference sign I1*, I2* or I1, I2 is used hereinafter.

In a step S5, the control device 9 accepts—for example, from the energy supply devices 8—the actual variables I1, I2 (more precisely: the corresponding values).

In a step S6, the control device 9 checks whether the first actual variables I1 correspond with the first setpoint variables I1*. If this is the case, the control device 9 passes to a step S7. In step S7, the control device 9 checks whether the second actual variables I2 correspond with the second setpoint variables I2*. If this is also the case, both the first and the second induction modules 6, 7 operate properly, so that no further measures have to be taken. Rather, the sequence can return directly to step S5.

If the check of step S7 has a negative result, (at least) one of the second actual variables I2 is reduced (in relation to the associated second setpoint variable I2*). In this case, the first induction modules 6 do operate properly, but not the second induction modules 7. The control device 9 therefore passes to a step S8, in which it carries out corresponding error handling.

If the check of step S6 has a negative result, the control device 9 passes to a step S9. In this case, at least one of the first induction modules 6 does not operate properly. In step S9, the control device 9 checks whether the second actual variables I2 correspond with the second setpoint variables I2*. If this is the case, the second induction modules 7 operate properly. In this case, the control device 9 passes to a step S10, in which it carries out corresponding error handling.

If the check of step S9 also has a negative result, both the first and the second induction modules 6, 7 do not operate properly. In this case, the control device 9 passes to a step S11, in which it carries out corresponding error handling.

A possible implementation of step S10 is explained hereinafter in conjunction with FIG. 4, thus the situation that the second induction modules 7 operate properly, but the first induction modules 6 do not. Without restriction of the generality, it is assumed in the scope of the following explanations that the first induction module 61 of the first module pair 51 does not operate properly, thus the actual variable I11 is less than the associated setpoint variable I11*. If another of the first induction modules 6 were not to operate properly, analogous statements would result. If a plurality of the first induction modules 6 were not to operate properly, the first induction modules 6 operating properly and the first induction modules 6 not operating properly would form two groups complementary to one another. Analogous statements would then also result.

To implement step S10, the control device 9 can first, for example, in a step S21, form the difference δI1 between the setpoint variable I11* and the actual variable I11. The control device 9 can then, in a step S22, based on the difference δI1, determine first additional values δI12* to δI15* for the remaining first induction modules 62 to 65. In the simplest case, for example, the control device 9 can attempt to distribute the difference δI1 uniformly onto the remaining (i.e. properly operating) first induction modules 62 to 65, wherein, however, corresponding maximum permissible electrical variables I12max to I15max of the induction modules 62 to 65 are taken into consideration. The allocation of the difference δI1 in fourths specifically results in the present case in that it was assumed that a total of five module pairs 5 are present, of which according to the condition the first induction module 6 of one of the module pairs 5 has failed and accordingly the difference δI1 can only be allocated onto the first induction modules 6 of the other four module pairs 5.

In a step S23, the first setpoint variables I12* to I15* are then increased by the first additional values δI12* to δI15*. Furthermore, in a step S24, the control unit 9 determines the difference δI1 now still remaining.

Steps S22 to S24 can optionally be carried out multiple times. However, in this case the allocation of the still remaining difference δI1 changes from iteration to iteration, namely from a fourth via a third to half and finally to the complete difference δI1.

In a step S25, the control device 9 checks whether the remaining difference δI1 has the value 0, thus whether the difference δI1 originally determined in step S21 could be completely allocated onto the remaining first induction modules 62 to 65. If this is the case, the procedure of FIG. 4 can be ended. If this is not the case, the control device 9 can proceed to a step S26 and, following this, to a step S27. Alternatively, steps S25 to S27 can also be omitted or measures other than those explained hereinafter can be taken in steps S26 and S27.

In step S26, the control device 9 determines second additional values δI21* to δI25* for the second induction modules 71 to 75. This determination takes place based on the remaining difference δI1, thus the difference δI1 determined during the (possibly ultimate) execution of step S24. In the simplest case, the control device 9 can, for example, distribute the remaining difference δI1 uniformly onto the second induction modules 71 to 75. In a step S27, the second setpoint variables I21* to I25* are then decreased or reduced by the second additional values δI21* to δI25*.

A numeric example in this regard:

If, for example, the first and second induction modules 6, 7 are each supposed to apply 2 MW (megawatts) to the rolled stock 2, the first and second setpoint variables I1*, I2* are thus defined accordingly, and the first induction module 61 completely fails (I11=0), the attempt is predominantly made to compensate for this failure by way of a correspondingly elevated application by the remaining first induction modules 62 to 65 to the rolled stock 2. The compensation is performed as much as possible. As a result, this means that the first setpoint variables I12* to I15* are increased by the first additional values δI12* to δI15*, but at most up to their maximum permissible values I12max to I15max. If the maximum permissible power of the induction modules 6, 7 is 2.5 MW or greater, this allocation can be performed. However, if the maximum permissible power of the induction modules 6, 7 is, for example, 2.25 MW, it is only possible to go up to this value. In this case, 1 MW remains, which cannot be compensated for by means of the remaining first induction modules 6.

If such a compensation is not possible, in general the modulation of the second induction modules 71 to 75 is reduced. This is effectuated by the reduction of the second setpoint variables I21* to I25* by the second auxiliary values δI21* to δI25*. According to the numeric example, the second setpoint variables I21* to I25* would therefore be reduced such that the second induction modules 7 each only still introduce 1.8 MW into the rolled stock 2. This is because the following then applies: 4×2.25 MW=9 MW=5×1.8 MW.

Alternatively, an asymmetry in the heating of the rolled stock 2 can be accepted if this is acceptable or is linked to lesser disadvantages than the reduction of the power introduced into the rolled stock 2.

A possible implementation of step S8 results on its own due to the implementation of step S10. This is because step S8 and step S10 can be viewed as mirror images of one another. Therefore, only step S11 is still explained in more detail hereinafter, thus the situation in which both the first and the second induction modules 6, 7 do not operate properly.

A possible implementation of step S11 is explained hereinafter in conjunction with FIG. 5, thus the situation that both the first induction modules 6 and the second induction modules 7 do not operate properly. Without restriction of the generality, it is assumed in the scope of the following explanations that the first induction module 61 of the first module pair 51 and the second induction module 75 of the fifth module pair 55 do not operate properly, thus the actual variable I11 is less than the associated setpoint variable I11* and the actual variable I25 is less than the associated setpoint variable I25*. If other ones of the first and second induction modules 6, 7 were not to operate properly, analogous statements would result. Analogous statements would likewise result if a plurality of the first induction modules 6 and/or a plurality of the second induction modules 7 were not to operate properly. In this case, four groups would possibly have to be formed, namely one group in each case for the properly operating first induction modules 6, the non-properly operating first induction modules 6, the properly operating second induction modules 7, and the non-properly operating second induction modules 7.

To implement step S11, the control device 9 can, for example, initially in a step S31 form the difference δI1 between the setpoint variable I11* and the actual variable I11 and then in a step S32, based on the difference δI1, determine the first additional values δI12* to δI15* for the remaining first induction modules 62 to 65. In a step S33, the first setpoint variables I12* to I15* are then increased by the first additional values δI12* to δI15*. Furthermore, in a step S34, the control device 9 determines the difference δI1 now still remaining.

To implement step S11, the control device 9 can then furthermore, in a step S35, form the difference δI2 between the setpoint variable I25* and the actual variable I25 and, in a step S36, based on the difference δI2, determine second additional values δI21* to δI24* for the remaining second induction modules 71 to 74. In a step S37, the second setpoint variables I21* to I24* are increased by the second additional values δI21* to δI24*. Furthermore, in a step S38, the control device 9 determines the difference δI2 now still remaining.

Steps S31 to S34 correspond in content with steps S21 to S24 of FIG. 4. Steps S35 to S38 likewise correspond in content with steps S21 to S24 of FIG. 4, but with the difference that they are not carried out with respect to the first induction modules 62 to 65, but rather with respect to the second induction modules 71 to 74. In both cases, however, reference can be made to the above statements on FIG. 4 for details.

In a step S39, the control device 9 checks whether the differences δI1 and δI2 determined in steps S34 and S38 have the same value. If this is the case, the control device 9 proceeds to a step S40. In step S40, further measures often do not have to be taken. However, in individual cases this can be necessary. This can apply in particular if differences δI1 and δI2 have the same value, but are not equal to 0.

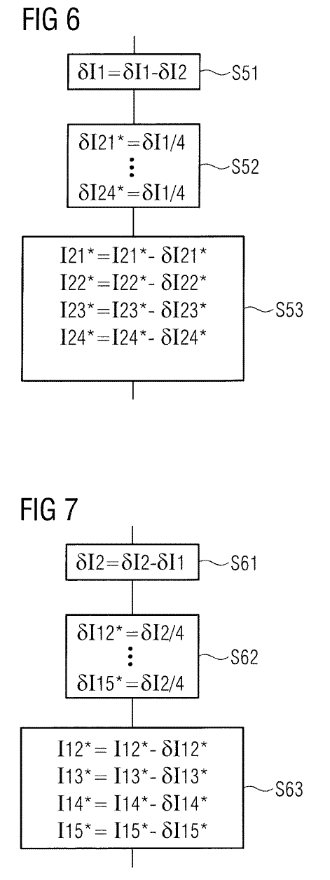

Otherwise, the control device 9 can check in a step S41 whether the difference δI1 is greater than the difference δI2. If this is the case, the control device 9 proceeds to a step S42. Otherwise, the control device 9 proceeds to a step S43. FIGS. 6 and 7 show possible implementations of steps S42 and S43.

To implement step S42, the control device 9 according to FIG. 6 can initially, in a step S51, determine the difference of the differences δI1 and δI2 as the resulting difference δI1. Furthermore, the control device 9, in a step S52, can again determine second additional values δI21* to δI24* for the second induction modules 71 to 74. In a step S53, the second setpoint variables I21* to I24* can be decreased or reduced by the second additional values δI21* to δI24*. Steps S52 and S53 substantially correspond in content with steps S26 und S27 of FIG. 4. For details, reference can therefore be made to the above statements on FIG. 4. The difference is solely in that steps S26 and S27 are carried out for all second induction modules 71 to 75, while steps S51 and S52 are only carried out for the second induction modules 71 to 74 (thus without the second induction module 75), and furthermore the difference δI1 still to be allocated, thus the difference δI1 determined in step S51, is not divided by 5, but only by 4, because only four second induction modules 7 are still available.

In an analogous manner, the control device 9 according to FIG. 7, to implement step S43, in a step S61, can determine the difference of the differences δI2 and δI1 as the resulting difference δI2. Furthermore, the control device 9, in a step S62, can again determine first additional values δI12* to δI15* for the first induction modules 62 to 65. In step S63, the first setpoint variables I12* to I15* can be decreased or reduced by the first additional values δI12* to δI15*. Steps S61 to S63 correspond in content with steps S51 to S53, but with the difference that they are not carried out with respect to the second induction modules 71 to 74, but rather with respect to the first induction modules 62 to 65.

Another numeric example in this regard:

If, for example, the first and second induction modules 6, 7 are each supposed to apply 2 MW (megawatts) to the rolled stock 2, the first and second setpoint variables I1*, I2* are thus defined accordingly, and the first induction module 61 and the second induction module 75 completely fail (I11=I25=0), the attempt is primarily made to compensate for these two failures by a correspondingly increased application to the rolled stock 2 by the remaining first and second induction modules 62 to 65, 71 to 74, thus to operate each of the remaining first and second induction modules 62 to 65, 71 to 74 using 2.5 MW. The compensation is performed as much as possible. As a result, this means that the first setpoint variables I12* to I15* and the second setpoint variables I21* to I24* are increased, but at most up to their maximum permissible values I12max to I15max, I21max to I24max. Provided such a compensation leads to asymmetrical results, the modulation of the first or the second induction modules 62 to 65, 71 to 74 can be reduced. This is effectuated in steps S53 and S63, which are alternatively executed, by the corresponding reduction of the respective setpoint variables I12* to I15*, I21* to I24* by the respective additional values δI12* to δI15*, δI21* to δI24*.

An asymmetry in the heating of the rolled stock 2 can possibly also be accepted in conjunction with the procedure according to FIG. 5 (and, building thereon, FIGS. 6 and 7), if this is acceptable or is linked to lesser disadvantages than the reduction of the power introduced into the rolled stock 2.

As a result, due to the procedure of FIGS. 3 to 7, measures are taken in each case, due to which a reduced heating of the rolled stock 2 caused by a reduced actual variable I11, I25 is compensated for as much as possible. However, in the event of a failure of a specific induction module 6, 7, the same measure is not always rigidly taken, but rather the respective situation is reacted to individually and in a matched manner. In particular, the behavior of the other induction modules 6, 7 is taken into consideration spanning the modules. This is in particular in contrast to the prior art. This is because in the prior art, in the event of a failure of a first induction module 6 of a specific module pair 5, the second induction module 7 of this module pair 5 is always also switched off. This is also the case in reverse. Only the first and second induction modules 6, 7 of the remaining module pairs 5 are still operated.

The difference in the procedure according to the invention is shown most clearly in the above procedure explained in conjunction with FIG. 5. In the prior art, the induction module 71 would also be switched off due to the failure of the induction module 61. Furthermore, the induction module 65 would also be switched off in the prior art due to the failure of the induction module 75. Therefore, the 20 MW, which a total of 10 induction modules 6, 7 would previously apply to the rolled stock 2 according to the numeric example, are applied in the prior art by the remaining six induction modules 62 to 64, 72 to 74. Each remaining induction module 6, 7 would thus have to apply about 3.3 MW to the rolled stock 2. If—for example—a single induction module 6, 7 could at most apply 3.0 MW to the rolled stock 2, however, this value could no longer be achieved. Only an application of at most 6×3.0 MW=18 MW would be possible. In contrast, in the procedure according to the invention, a total of eight induction modules 62 to 65, 71 to 74 remain in operation. Therefore, to apply a total of 20 MW to the rolled stock 2, each remaining induction module 62 to 65, 71 to 74 would only have to apply 2.5 MW to the rolled stock 2, which is within the permissible load limits according to the numeric example.

In many cases, no further measures are required beyond the procedures of FIGS. 3 to 7. In the case of FIG. 5, however, it is possible in the scope of steps S40, S42, and S43 to additionally move the first induction modules 6 or at least the remaining first induction modules 62 to 65 by position changes δp1, specifically proceeding from their respective starting positions p1*. Likewise, it is possible, vice versa, to move the second induction modules 7 or at least the remaining second induction modules 71 to 74 by position changes δp2, specifically proceeding from their respective starting positions p2*. The corresponding travel movements are indicated in FIG. 2 for the frontmost two induction modules 6, 7 by arrows 13. In the case of FIG. 4, the movement only takes place for the second induction modules 7 or at least the remaining second induction modules 71 to 74.

Furthermore, on the outlet side of the induction furnace 1, the temperature profile T2 can be detected and compared with a desired outlet-side temperature profile T2* (thus a setpoint variable or target variable for the final temperature profile T2), so that as a result a control loop is formed.

A very simple procedure was explained above for this purpose, by means of which the setpoint variables I12* to I15* and/or I21* to I24* can be determined for the remaining first and/or second induction modules 62 to 65, 71 to 74. A progressive or degressive staggering is likewise also possible, thus that the additional values δI11* to δI15*, δI21* to δI25* are greater (degressive case) or lesser (progressive case) the closer an observed induction module 6, 7 is arranged to a failed induction module 6, 7.

This procedure often already results in significant improvements in relation to the prior art. It is even better if the control device 9, according to the illustration in FIG. 1, knows various further variables and the control device 9 determines the additional values δI12* to δI15*, δI21* to δI25* as a function of these variables. The same possibly applies for the determination of the position changes δp1, δp2. The mentioned variables can in particular comprise the initial temperature profile T1, the desired final temperature profile T2*, and operating parameters of the induction furnace 1. In particular the thickness and the speed v of the rolled stock 2 and/or the time span t which a specific section of the rolled stock 2 requires to pass through the induction furnace 1 come into consideration as operating parameters of the induction furnace 1. The control device 9 can in this case, for example, implement a model of the induction furnace 1 and the rolled stock 2. For example, radiation losses can be calculated in the model and therefore taken into consideration.

The present invention has many advantages. In particular, reliable operation of the induction furnace 1 is ensured. This is true in particular if multiple induction modules 6, 7 fail, which are associated with various module pairs 5. In particular in this case, the operation of the induction furnace 1 is ensured longer than if—as in the prior art—in the event of failure of one induction module 6, 7 of a specific module pair 5, the other induction module 7, 6 of this module pair 5 would also always be switched off. As a result, a significantly higher level of flexibility and process stability therefore results.

Although the invention was illustrated and described in more detail by the preferred exemplary embodiments, the invention is not restricted by the disclosed examples and other variations can be derived therefrom by a person skilled in the art without departing from the scope of protection of the invention.

List of reference signs

| | |
|---|---|
| 1 | induction furnace |
| 2 | rolled stock |
| 3, 4 | rolled stock edges |
| 5, 51 to 55 | module pairs |
| 6, 61 to 66 | induction modules |
| 7, 71 to 75 | induction modules |
| 8 | energy supply devices |
| 9 | control device |
| 10 | control program |
| 11 | machine code |
| 12 | positioning devices |
| 13 | arrows |
| b | width |
| I1, I11 to I15 | actual variables |
| I1*, I11* to I15* | setpoint variables |
| I12max to I15max | maximum permissible variables |
| I21max to I24max | maximum permissible variables |
| I2, I21 to I25 | actual variables |
| I2*, I21* to I25* | setpoint variables |
| p1* | starting positions |
| p2* | starting positions |
| S1 to S62 | steps |
| t | time span |
| T1, T2, T2* | temperature profiles |
| v | speed |
| x | longitudinal direction |
| y | transverse direction |
| δI1, δI2 | differences |
| δI12* to δI15* | additional values |
| δI21* to δI25* | additional values |
| δp1, δp2 | position changes |

1-10. (canceled)

11. A heating method for a flat rolled stock made of metal in an induction furnace,
wherein the rolled stock passes through the induction furnace in a longitudinal direction and extends from a first to a second rolled stock edge in a transverse direction running transversely to the longitudinal direction;
wherein the induction furnace comprises a plurality of module pairs;
wherein the module pairs follow one another sequentially viewed in the longitudinal direction and each comprise a first and a second induction module;
the heating method comprising:
positioning the induction modules at a respective starting position viewed in the transverse direction;
determining the starting positions such that the first induction modules are arranged offset toward the first rolled stock edge and the second induction modules are arranged offset toward the second rolled stock edge;
supplying each of the induction modules with electric energy via a separate energy supply device proprietarily assigned to the respective induction module;
defining a respective electric setpoint variable for the induction modules; and
monitoring whether electric actual variables, using which the induction modules are operated, correspond with their respective setpoint variables;
wherein, in the case that exclusively an actual variable, using which one of the first induction modules is operated, has a reduced value in relation to its corresponding setpoint variable, while maintaining the operation of all second induction modules, the setpoint variables, both the setpoint variables for the first induction modules, which are upstream from that first induction module, the actual variable of which has a reduced value in relation to its corresponding setpoint variable, and also the setpoint variables for the first induction modules, which are downstream from that first induction module, the actual variable of which has a reduced value in relation to its corresponding setpoint variable, are increased, so that a reduced heating of the rolled stock caused by the reduced actual variable is compensated for as much as possible.

12. The heating method as claimed in claim 11, wherein, if a compensation of the reduced heating of the rolled stock is not possible, the second setpoint variables of a plurality of the second induction modules are reduced.

13. The heating method as claimed in claim 11, wherein the second induction modules are additionally moved, starting from their respective starting positions.

14. The heating method as claimed in claim 11, wherein, in the case that both an actual variable, using which one of the first induction modules is operated, and an actual variable, using which one of the second induction modules is operated, have a reduced value in relation to their corresponding setpoint variable, the setpoint variables for the first induction modules, which are upstream from that first induction module, the actual variable of which has a reduced value in relation to its corresponding setpoint variable, the setpoint variables for the first induction modules, which are downstream from that first induction module, the actual variable of which has a reduced value in relation to its corresponding setpoint variable, the setpoint variables for the second induction modules, which are upstream from that second induction module, the actual variable of which has a reduced value in relation to its corresponding setpoint variable, and the setpoint variables for the second induction modules, which are downstream from that second induction module, the actual variable of which has a reduced value in relation to its corresponding setpoint variable, are increased, so that a reduced heating of the rolled stock caused by the reduced actual variables is compensated for as much as possible.

15. The heating method as claimed in claim 14, wherein the remaining first and second induction modules are additionally moved, starting from their respective starting positions.

16. The heating method as claimed in claim 11, wherein additional values, by which the setpoint variables for the first and second induction modules are increased or reduced, are determined as a function of an initial temperature profile of the flat rolled stock before the feed to the induction furnace, operating parameters of the induction furnace, and a desired final temperature profile of the flat rolled stock after the departure from the induction furnace.

17. A control program for a control device of an induction furnace, in which a flat rolled stock made of metal is to be heated;
wherein the rolled stock passes through the induction furnace in a longitudinal direction and extends from a first to a second rolled stock edge in a transverse direction running transversely to the longitudinal direction;
wherein the induction furnace comprises a plurality of module pairs;
wherein the module pairs follow one another sequentially viewed in the longitudinal direction and each comprise a first and a second induction module;
wherein the induction modules are positioned at a respective starting position viewed in the transverse direction;
wherein the starting positions are determined such that the first induction modules are arranged offset toward the first rolled stock edge and the second induction modules are arranged offset toward the second rolled stock edge;
wherein the induction modules are each supplied with electric energy via a separate energy supply device proprietarily assigned to the respective induction module;
wherein a respective electric setpoint variable is defined for the induction modules, wherein the control program comprises machine code, which is executable by the control device;
wherein the execution of the machine code by the control device causes the control device to monitor whether electric actual variables, using which the induction modules are operated, correspond with their respective setpoint variables; and
wherein in the case that exclusively an actual variable, using which one of the first induction modules is operated, has a reduced value in relation to its corresponding setpoint variable, while maintaining the operation of all second induction modules, both the setpoint variables for the first induction modules, which are upstream from that first induction module, the actual variable of which has a reduced value in relation to its corresponding setpoint variable, and also the setpoint variables for the first induction modules, which are downstream from that first induction module, the actual variable of which has a reduced value in relation to its corresponding setpoint variable, are increased, so that a reduced heating of the rolled stock caused by the reduced actual variable is compensated for as much as possible.

18. The control program as claimed in claim 17, wherein, if a compensation of the reduced heating of the rolled stock is not possible, the second setpoint variables of a plurality of the second induction modules are reduced.

19. The control program as claimed in claim 17, wherein the second induction modules are additionally moved, starting from their respective starting positions.

20. The control program as claimed in claim 17, wherein, in the case that both an actual variable, using which one of the first induction modules is operated, and an actual variable, using which one of the second induction modules is operated, have a reduced value in relation to their corresponding setpoint variable, the setpoint variables for the first induction modules, which are upstream from that first induction module, the actual variable of which has a reduced value in relation to its corresponding setpoint variable, the setpoint variables for the first induction modules, which are downstream from that first induction module, the actual variable of which has a reduced value in relation to its corresponding setpoint variable, the setpoint variables for the second induction modules, which are upstream from that second induction module, the actual variable of which has a reduced value in relation to its corresponding setpoint variable, and the setpoint variables for the second induction modules, which are downstream from that second induction module, the actual variable of which has a reduced value in relation to its corresponding setpoint variable, are increased, so that a reduced heating of the rolled stock caused by the reduced actual variables is compensated for as much as possible.

21. The control program as claimed in claim 20, wherein the remaining first and second induction modules are additionally moved, starting from their respective starting positions.

22. The control program as claimed in claim 17, wherein additional values, by which the setpoint variables for the first and second induction modules are increased or reduced, are determined as a function of an initial temperature profile of the flat rolled stock before the feed to the induction furnace, operating parameters of the induction furnace, and a desired final temperature profile of the flat rolled stock after the departure from the induction furnace.

23. A control device of an induction furnace, in which a flat rolled stock made of metal is to be heated, wherein the control device is programmed using a control program for a control device of an induction furnace, in which a flat rolled stock made of metal is to be heated;
wherein the rolled stock passes through the induction furnace in a longitudinal direction and extends from a first to a second rolled stock edge in a transverse direction running transversely to the longitudinal direction;
wherein the induction furnace comprises a plurality of module pairs;
wherein the module pairs follow one another sequentially viewed in the longitudinal direction and each comprise a first and a second induction module;
wherein the induction modules are positioned at a respective starting position viewed in the transverse direction;
wherein the starting positions are determined such that the first induction modules are arranged offset toward the first rolled stock edge and the second induction modules are arranged offset toward the second rolled stock edge;
wherein the induction modules are each supplied with electric energy via a separate energy supply device proprietarily assigned to the respective induction module;
wherein a respective electric setpoint variable is defined for the induction modules, wherein the control program comprises machine code, which is executable by the control device;
wherein the execution of the machine code by the control device causes the control device to monitor whether electric actual variables, using which the induction modules are operated, correspond with their respective setpoint variables;
wherein in the case that exclusively an actual variable, using which one of the first induction modules is operated, has a reduced value in relation to its corresponding setpoint variable, while maintaining the operation of all second induction modules, both the setpoint variables for the first induction modules, which are upstream from that first induction module, the actual variable of which has a reduced value in relation to its corresponding setpoint variable, and also the setpoint variables for the first induction modules, which are downstream from that first induction module, the actual variable of which has a reduced value in relation to its corresponding setpoint variable, are increased, so that a reduced heating of the rolled stock caused by the reduced actual variable is compensated for as much as possible; and
wherein the control device operates the induction furnace according to the heating method as claimed in claim 11.

24. An induction furnace for heating a flat rolled stock made of metal, which passes through the induction furnace in a longitudinal direction and extends from a first to a second rolled stock edge in a transverse direction running transversely to the longitudinal direction,
wherein the induction furnace comprises a plurality of module pairs,
wherein the module pairs follow one another sequentially viewed in the longitudinal direction and each comprise a first and a second induction module,
wherein the induction modules are positioned at a respective starting position viewed in the transverse direction,
wherein the starting positions are determined such that the first induction modules are arranged offset toward the first rolled stock edge and the second induction modules are arranged offset toward the second rolled stock edge,
wherein the induction modules are each supplied with electric energy via a separate energy supply device proprietarily assigned to the respective induction module,
wherein the induction furnace comprises a control device of an induction furnace, in which a flat rolled stock made of metal is to be heated, wherein the control device is programmed using a control program for a control device of an induction furnace, in which a flat rolled stock made of metal is to be heated;
wherein the rolled stock passes through the induction furnace in a longitudinal direction and extends from a first to a second rolled stock edge in a transverse direction running transversely to the longitudinal direction;
wherein the induction furnace comprises a plurality of module pairs;
wherein the module pairs follow one another sequentially viewed in the longitudinal direction and each comprise a first and a second induction module;
wherein the induction modules are positioned at a respective starting position viewed in the transverse direction;
wherein the starting positions are determined such that the first induction modules are arranged offset toward the first rolled stock edge and the second induction modules are arranged offset toward the second rolled stock edge;
wherein the induction modules are each supplied with electric energy via a separate energy supply device proprietarily assigned to the respective induction module;
wherein a respective electric setpoint variable is defined for the induction modules, wherein the control program comprises machine code, which is executable by the control device;
wherein the execution of the machine code by the control device causes the control device to monitor whether electric actual variables, using which the induction modules are operated, correspond with their respective setpoint variables;
wherein in the case that exclusively an actual variable, using which one of the first induction modules is operated, has a reduced value in relation to its corresponding setpoint variable, while maintaining the operation of all second induction modules, both the setpoint variables for the first induction modules, which are upstream from that first induction module, the actual variable of which has a reduced value in relation to its corresponding setpoint variable, and also the setpoint variables for the first induction modules, which are downstream from that first induction module, the actual variable of which has a reduced value in relation to its corresponding setpoint variable, are increased, so that a reduced heating of the rolled stock caused by the reduced actual variable is compensated for as much as possible; and
wherein the control device controls the induction furnace according to the heating method as claimed in claim 11.
